(19) United States
(12) Patent Application Publication
(10) Pub. No.: US 2026/0337310 A1
(43) Pub. Date: Oct. 29, 2026

(54) RUBBER COMPOSITION FOR SIDEWALL AND PNEUMATIC TIRE USING THE SAME

(71) Applicant: Toyo Tire Corporation, Itami-shi (JP)

(72) Inventor: Kanae ABE, Itami-shi (JP)

(73) Assignee: Toyo Tire Corporation, Itami-shi (JP)

(21) Appl. No.: 19/560,432

(22) Filed: Mar. 9, 2026

(30) Foreign Application Priority Data
Mar. 19, 2025 (JP) 2025-044586

(51) Int. Cl. C08F 36/06; B60C 1/00; C08K 3/04; C08K 3/36; C08K 5/25

(52) U.S. Cl. CPC C08F 36/06; B60C 1/0025; C08K 3/04; C08K 3/36; C08K 5/25

(57) ABSTRACT

A rubber composition for a sidewall according to an embodiment contains: a diene rubber component containing a natural rubber and a butadiene rubber; carbon black having a nitrogen adsorption specific surface area (N₂SA) of 20 m²/g to 60 m²/g; silica; a hydrazide compound represented by the following general formula (1); a vulcanization accelerator; and sulfur. In the formula (1), R¹ and R² each independently represent an alkyl group having 1 to 18 carbon atoms. Relative to 100 parts by mass of the diene rubber component, a content of the carbon black is 20 parts by mass to 50 parts by mass, and a content of the hydrazide compound is 0.5 parts by mass to 5.0 parts by mass, and a mass ratio of the vulcanization accelerator to the sulfur is 0.60 to 2.00.

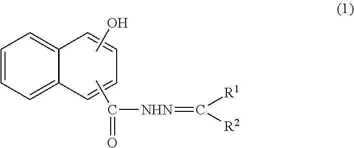

### BACKGROUND OF THE INVENTION

### 1. Field of the Invention

The present invention relates to a rubber composition for a sidewall and a pneumatic tire using the same.

### 2. Description of Related Art

It is known to compound a hydrazide compound into a rubber composition. For example, JP2001-172435A discloses a method for producing a rubber composition including a rubber kneading step, in which a specific hydrazide compound and zinc white are simultaneously added to a rubber component made of a natural rubber and/or a diene-based synthetic rubber, and the mixture is kneaded at a maximum temperature of 130 °C to 170 °C. JP2001-172435A describes that accordingly, a rubber composition that can stably improve low heat generation properties, fracture resistance, and tear resistance is obtained.

JP2004-123926A describes a use of a rubber composition as a tire member, which contains a rubber component made of at least one rubber selected from natural rubber and diene-based synthetic rubber, silica heat-treated with silicone oil, and a specific hydrazone compound. JP2004-123926A describes that accordingly, processability and productivity during tire manufacturing are improved, and low heat generation properties is improved while maintaining or improving abrasion resistance without adversely affecting other physical properties of vulcanized rubber.

JP2022-074261A discloses a rubber composition for a tire in which a diene rubber containing 80 mass % or more of natural rubber is compounded with carbon black, a maleic acid-modified rosin resin, and a specific hydrazide compound. JP2022-074261A describes that accordingly, fracture resistance is improved without deteriorating the low heat generation properties.

### SUMMARY OF THE INVENTION

In recent years, there is an ever-increasing demand for lower fuel consumption of tires. To meet this demand, improvements in low heat generation properties are required not only in a cap tread but also in various tire members such as a sidewall. However, if a compounding amount of a filler such as carbon black is reduced to improve the low heat generation properties, hardness tends to decrease and handling stability tends to deteriorate. When the low heat generation properties is improved by increasing a crosslinking density of the rubber, cut resistance tends to deteriorate. Accordingly, it is difficult to achieve both the low heat generation properties and good hardness and cut resistance.

In view of the above, an object of an embodiment of the invention is to provide a rubber composition for a sidewall that can improve low heat generation properties while maintaining or improving hardness, cut resistance, and bending fatigue resistance, and a pneumatic tire using the same.

The invention includes embodiments shown below.
[1] A rubber composition for a sidewall, containing:
a diene rubber component containing a natural rubber and a butadiene rubber;
carbon black having a nitrogen adsorption specific surface area (N₂SA) of 20 m²/g to 60 m²/g;
silica;
a hydrazide compound represented by the following general formula (1):

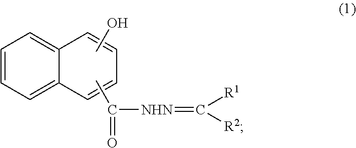

a vulcanization accelerator; and
sulfur, in which
in the formula (1), R¹ and R² each independently represent an alkyl group having 1 to 18 carbon atoms,
relative to 100 parts by mass of the diene rubber component, a content of the carbon black is 20 parts by mass to 50 parts by mass, and a content of the hydrazide compound is 0.5 parts by mass to 5.0 parts by mass, and
a mass ratio of the vulcanization accelerator to the sulfur is 0.60 to 2.00.
[2] The rubber composition for a sidewall according to [1], in which 100 parts by mass of the diene rubber component contains 40 parts by mass to 60 parts by mass of the natural rubber and 40 parts by mass to 60 parts by mass of the butadiene rubber.
[3] The rubber composition for a sidewall according to [1] or [2], in which relative to 100 parts by mass of the diene rubber component, a content of the silica is 5 parts by mass to 20 parts by mass.
[4] The rubber composition for a sidewall according to any one of [1] to [3], in which
relative to 100 parts by mass of the diene rubber component, a total content of the carbon black and the silica is 30 parts by mass to 55 parts by mass.
[5] The rubber composition for a sidewall according to any one of [1] to [4], in which
a content ratio of the carbon black to the silica (carbon black/silica) is 2 to 9 in terms of mass ratio.
[6] The rubber composition for a sidewall according to any one of [1] to [5], in which
the vulcanization accelerator contains a sulfenamide-based vulcanization accelerator.
[7] A pneumatic tire including:
a sidewall produced using the rubber composition for a sidewall according to any one of [1] to [6].

According to the embodiments of the invention, it is possible to improve low heat generation properties while maintaining or improving hardness, cut resistance, and bending fatigue resistance.

### DESCRIPTION OF EMBODIMENTS

A rubber composition for a sidewall according to the present embodiment (hereinafter, referred to as a rubber composition) contains: (A) a diene rubber component containing a natural rubber and a butadiene rubber; (B) carbon black having a nitrogen adsorption specific surface area (N₂SA) of 20 m²/g to 60 m²/g; (C) silica; (D) a hydrazide compound represented by a general formula (1); (E) a vulcanization accelerator; and (F) sulfur.

### (A) Diene Rubber Component

In the present embodiment, the diene rubber component contains a natural rubber (NR) and a butadiene rubber (BR).

The natural rubber is a polymer of isoprene, and mainly made of cis-1,4 bonds. As the natural rubber, various natural rubbers generally used in rubber compositions for tires can be used.

The butadiene rubber is a polymer of 1,3-butadiene and is also called a polybutadiene rubber. As the butadiene rubber, various butadiene rubbers generally used in rubber compositions for tires can be used. The butadiene rubber may be a modified butadiene rubber whose chain end and/or main chain are modified, or may be a non-modified butadiene rubber, or a combination thereof.

The butadiene rubber may contain a high-cis butadiene rubber (high-cis BR) having a cis-1,4 bond content of 90 mass % or more. The cis-1,4 bond content of the high-cis BR is more preferably 96 mass % or more. Preferably, the high-cis BR is unmodified. In one embodiment, it is preferred that 50 mass % or more, more preferably 80 mass % or more of the butadiene rubber is the high-cis BR, and the butadiene rubber may solely contain the high-cis BR.

Examples of the high-cis BR include those synthesized using a cobalt-based catalyst and those synthesized using a rare earth-based catalyst. As the rare earth element-based catalyst, a neodymium-based catalyst is preferable, and examples thereof include simple neodymium, compounds of neodymium with other metals, and organic compounds. More specifically, specific examples thereof include NdCl₃ and Et-NdCl₂. A butadiene rubber synthesized with a neodymium-based catalyst has a microstructure with a high cis content and a low vinyl content. Therefore, the low heat generation properties can be further improved as compared with butadiene rubbers synthesized using other catalysts, including cobalt-based catalysts. The microstructure of the butadiene rubber synthesized using a neodymium-based catalyst preferably has a cis-1,4 bond content of 96 mass % or more and a vinyl group (1,2-vinyl bond) content of 1.0 mass % or less.

In the present specification, the cis-1,4 bond content and the vinyl group content are values measured using ¹H-NMR spectroscopy.

In the present embodiment, the diene rubber component may contain only the above-mentioned natural rubber and the butadiene rubber, and other diene rubbers may be further compounded within a range that does not impair the effects of the present embodiment. The diene rubber refers to a rubber having a repeating unit corresponding to a diene monomer having a conjugated double bond. Specific examples of other diene rubbers include various diene rubbers that are commonly used in rubber compositions, such as synthetic isoprene rubbers (IR), styrene-butadiene rubbers (SBR), nitrile rubbers (NBR), chloroprene rubbers (CR), styrene-isoprene copolymer rubbers, butadiene-isoprene copolymer rubbers, and styrene-isoprene-butadiene copolymer rubbers. The concept of these other diene rubbers also includes those whose chain end or main chain has been modified as necessary (for example, a chain end-modified SBR).

In one embodiment, 100 parts by mass of the diene rubber component preferably contains 40 parts by mass to 60 parts by mass of the natural rubber and 40 parts by mass to 60 parts by mass of the butadiene rubber.

### (B) Carbon Black

The rubber composition according to the present embodiment contains carbon black having a nitrogen adsorption specific surface area (N₂SA) of 20 m²/g to 60 m²/g. In this way, it is easy to improve a balance between the low heat generation properties and reinforcement. The nitrogen adsorption specific surface area (N₂SA) of the carbon black is preferably 25 m²/g to 50 m²/g, and more preferably 25 m²/g to 45 m²/g. Any carbon black having such an N₂SA may be used, or two or more kinds thereof may be used in combination. Here, the nitrogen adsorption specific surface area (N₂SA) of the carbon black is measured in accordance with JIS K6217-2 Method A:2017.

As the carbon black having the above N₂SA, for example, FEF grade (N500 series), GPF grade (N600 series), and SRF grade (N700 series) (all ASTM grades) are preferably used. Any one or a combination of two or more of the carbon black of each grade can be used.

Relative to 100 parts by mass of the diene rubber component, a content of the carbon black is 20 parts by mass to 50 parts by mass, preferably 25 parts by mass to 45 parts by mass, and more preferably 30 parts by mass to 40 parts by mass.

### (C) Silica

The rubber composition according to the present embodiment contains silica. Examples of the silica include wet silica and dry silica. Preferably, wet silica such as precipitated silica or gelled silica is used.

In one embodiment, relative to 100 parts by mass of the diene rubber component, a content of the silica is preferably 5 parts by mass to 20 parts by mass, more preferably 5 parts by mass to 15 parts by mass, and still more preferably 5 parts by mass to 10 parts by mass.

Relative to 100 parts by mass of the diene rubber component, a total content of the carbon black and the silica is preferably 30 parts by mass to 55 parts by mass, and more preferably 35 parts by mass to 45 parts by mass.

A content ratio of the carbon black to the silica, that is, a ratio of the content of the carbon black to the content of the silica (carbon black/silica) is preferably 2 to 9, and more preferably 3 to 8, in terms of mass ratio.

### (D) Hydrazide Compound

The rubber composition according to the present embodiment contains a hydrazide compound represented by the following general formula (1).

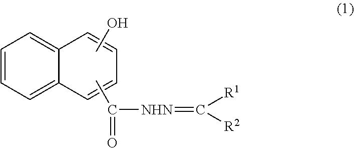

In the formula (1), R¹ and R² each independently represent an alkyl group having 1 to 18 carbon atoms, and examples thereof include a methyl group, an ethyl group, a propyl group, an isopropyl group, a butyl group, an isobutyl group, a sec-butyl group, a tert-butyl group, a pentyl group, a hexyl group, a heptyl group, an octyl group, a nonyl group, a decyl group, an undecyl group, a dodecyl group, a tridecyl group, a tetradecyl group, a pentadecyl group, a hexadecyl group, a heptadecyl group, and an octadecyl group. The number of carbon atoms in each of R¹ and R² is preferably 1 to 10, and more preferably 1 to 5.

In the formula (1), a bonding position of the hydrazide group (—CO—NHN═CR¹R²) to the naphthalene ring is preferably at the 2-position. A bonding position of the hydroxy group (—OH) to the naphthalene ring is preferably at the 1-position or 3-position.

Examples of the hydrazide compound represented by the general formula (1) include 1-hydroxy-N′-(1-methylethylidene)-2-naphthoic acid hydrazide, 1-hydroxy-N′-(1-methylpropylidene)-2-naphthoic acid hydrazide, 1-hydroxy-N′-(1-methylbutylidene)-2-naphthoic acid hydrazide, 1-hydroxy-N′-(1,3-dimethylbutylidene)-2-naphthoic acid hydrazide, 3-hydroxy-N′-(1-methylethylidene)-2-naphthoic acid hydrazide, 3-hydroxy-N′-(1-methylpropylidene)-2-naphthoic acid hydrazide, 3-hydroxy-N′-(1-methylbutylidene)-2-naphthoic acid hydrazide, and 3-hydroxy-N′-(1,3-dimethylbutylidene)-2-naphthoic acid hydrazide. Preferably, 3-hydroxy-N′-(1,3-dimethylbutylidene)-2-naphthoic acid hydrazide is used. These hydrazide compounds may be used alone or in combination of two or more kinds thereof. These compounds can be synthesized according to the synthesis method described in JPH10-330549A.

In the present embodiment, relative to 100 parts by mass of the diene rubber component, a content of the hydrazide compound is 0.5 parts by mass to 5.0 parts by mass, preferably 0.6 parts by mass to 4.0 parts by mass, and more preferably 0.7 parts by mass to 3.0 parts by mass.

### (E) Vulcanization Accelerator

The rubber composition according to the present embodiment contains a vulcanization accelerator. Examples of the vulcanization accelerator include various vulcanization accelerators such as sulfenamide-based, guanidine-based, thiuram-based, and thiazole-based vulcanization accelerators. Preferably, in one embodiment, the vulcanization accelerator contains a sulfenamide-based vulcanization accelerator. In this case, it is preferable that 50 mass % or more, more preferably 70 mass % or more, and still more preferably 90 mass % or more of the vulcanization accelerator is the sulfenamide-based vulcanization accelerator.

A content of the vulcanization accelerator is not particularly limited, and is preferably 0.8 parts by mass to 3.0 parts by mass, more preferably 0.9 parts by mass to 2.5 parts by mass, and still more preferably 1.0 part by mass to 2.0 parts by mass, relative to 100 parts by mass of the diene rubber component.

### (F) Sulfur

The rubber composition according to the present embodiment contains sulfur as a vulcanizing agent. Examples of the sulfur include powdered sulfur, precipitated sulfur, colloidal sulfur, insoluble sulfur, and high dispersing sulfur, which may be oil-treated.

A content of the sulfur is not particularly limited, and is preferably 0.7 parts by mass to 2.5 parts by mass, more preferably 0.8 parts by mass to 2.0 parts by mass, and still more preferably 0.9 parts by mass to 1.8 parts by mass, relative to 100 parts by mass of the diene rubber component. Note that the amount of the sulfur refers to the pure sulfur content excluding oil, even when oil-treated sulfur is used (the same applies to the following mass ratio (vulcanization accelerator/sulfur)).

In the present embodiment, the vulcanization accelerator and the sulfur are compounded such that a mass ratio of the vulcanization accelerator to the sulfur (vulcanization accelerator/sulfur) is 0.60 to 2.00. By using a combination of the natural rubber and the butadiene rubber as the diene rubber component, using the above-mentioned specific hydrazide compound, and further specifying the mass ratio of the vulcanization accelerator to the sulfur as described above to control the crosslinking form, it is possible to improve the low heat generation properties while maintaining or improving hardness, cut resistance, and bending fatigue resistance. The mass ratio (vulcanization accelerator/sulfur) is preferably 0.60 to 1.90, more preferably 0.70 to 1.60, and still more preferably 0.80 to 1.50.

In addition to the components described above, various additives generally used in rubber compositions, such as a silane coupling agent, oil, wax, an antioxidant, zinc oxide, stearic acid, a resin, and a processing aid, can be compounded in the rubber composition according to the present embodiment. Carbon black and other fillers other than the component (B) may be contained within a range that does not impair the effects of the present embodiment.

A content of the silane coupling agent is not particularly limited, and may be, for example, 0 parts by mass to 5 parts by mass, 0.5 parts by mass to 3 parts by mass, or 0.7 parts by mass to 2 parts by mass, relative to 100 parts by mass of the diene rubber component.

A content of the oil is not particularly limited, and may be, for example, 0 parts by mass to 10 parts by mass, 0.5 parts by mass to 5 parts by mass, or 1 part by mass to 3 parts by mass, relative to 100 parts by mass of the diene rubber component.

A content of the wax is not particularly limited, and may be, for example, 0 parts by mass to 10 parts by mass, 0.5 parts by mass to 5 parts by mass, or 1 part by mass to 4 parts by mass, relative to 100 parts by mass of the diene rubber component.

Examples of the antioxidant include various antioxidants such as amine-ketone-based, aromatic secondary amine-based, monophenol-based, bisphenol-based, and benzimidazole-based antioxidants. These antioxidants may be used alone or in combination of two or more kinds thereof. A content of the antioxidant is not particularly limited, and may be, for example, 0 parts by mass to 10 parts by mass, 1 part by mass to 8 parts by mass, or 3 parts by mass to 6 parts by mass, relative to 100 parts by mass of the diene rubber component.

A content of the zinc oxide is not particularly limited, and may be, for example, 0 parts by mass to 10 parts by mass, 0.5 parts by mass to 5 parts by mass, or 1 part by mass to 4 parts by mass, relative to 100 parts by mass of the diene rubber component.

A content of the stearic acid is not particularly limited, and may be, for example, 0 parts by mass to 10 parts by mass, 0.5 parts by mass to 5 parts by mass, or 1 part by mass to 4 parts by mass, relative to 100 parts by mass of the diene rubber component.

Examples of the resin include hydrocarbon resins such as aliphatic hydrocarbon resins, aromatic hydrocarbon resins, and aliphatic/aromatic hydrocarbon resins. A content of the resin is not particularly limited, and may be, for example, 0 parts by mass to 10 parts by mass, 0.5 parts by mass to 5 parts by mass, or 1 part by mass to 4 parts by mass, relative to 100 parts by mass of the diene rubber component.

A content of the processing aid is not particularly limited, and may be, for example, 0 parts by mass to 10 parts by mass, 0.5 parts by mass to 5 parts by mass, or 1 part by mass to 3 parts by mass, relative to 100 parts by mass of the diene rubber component.

The rubber composition according to the present embodiment can be produced by kneading according to a common method by using a mixer such as a Banbury mixer, a kneader, or a roll that is normally used. That is, in a first mixing stage, other additives excluding the vulcanization accelerator and the sulfur are added to and mixed with the diene rubber component. Next, the vulcanization accelerator and the sulfur can be added to and mixed with the resulting mixture in a final mixing stage to prepare the rubber composition.

The rubber composition thus obtained is suitable for use in a sidewall. For example, the rubber composition is extrusion-molded to have a predetermined cross-sectional shape corresponding to the sidewall to obtain an unvulcanized sidewall member. Alternatively, a ribbon-shaped rubber strip made of the above rubber composition is spirally wound on a drum and formed to have a cross-sectional shape corresponding to the sidewall, thereby obtaining an unvulcanized sidewall member. The sidewall member is assembled into a tire shape according to a common method together with other tire members that constitute a tire, such as an inner liner, a carcass, a belt, a bead core, a bead filler, and a tread, to obtain a green tire (an unvulcanized tire). The resulting green tire is then vulcanized and molded according to a common method at, for example, 140 °C to 180 °C, to obtain a pneumatic tire having a sidewall made of the above-mentioned sidewall member.

A type of the pneumatic tire according to the present embodiment is not particularly limited, and examples thereof include various types of tires such as a passenger car tire, and a heavy-duty tire for a truck or a bus.

### EXAMPLES

Hereinafter, Examples of the invention will be shown, but the invention is not limited to these Examples.

Details of raw materials used in Examples and Comparative Examples are as follows.
Natural rubber: RSS #3
Butadiene rubber: “Buna CB22” manufactured by Lanxess (cis-1,4 bond content 97 mass %, vinyl group content 0.4 mass %)
Carbon black-1: “N339 SEAST KH” manufactured by TOKAI CARBON CO., LTD. (nitrogen adsorption specific surface area (N₂SA)=93 m²/g)
Carbon black-2: FEF, “SEAST SO” manufactured by TOKAI CARBON CO., LTD. (nitrogen adsorption specific surface area (N₂SA)=42 m²/g)
Carbon black-3: GPF, “SEAST V” manufactured by TOKAI CARBON CO., LTD. (nitrogen adsorption specific surface area (N₂SA)=27 m²/g)
Silica: “Nipsil AQ” manufactured by Tosoh Silica Corporation
Hydrazide compound: “DC-01” manufactured by Otsuka Chemical Co., Ltd. (3-hydroxy-N′-(1,3-dimethylbutylidene)-2-naphthoic acid hydrazide, R¹=methyl group, R²=isobutyl group)
Silane coupling agent: “Si75” manufactured by Evonik Japan Co., Ltd.
Oil: “Process NC-140” manufactured by ENEOS Corporation
Wax: “OZOACE 1722” manufactured by NIPPON SEIRO CO., LTD.
Antioxidant-1: “Nocrac 6C” manufactured by Ouchi Shinko Chemical Industrial Co., Ltd.
Antioxidant-2: “ANTIOXIDANT TMQ” manufactured by Kemai Chemical Co., Ltd.
Zinc oxide: “Zinc oxide type 3” manufactured by Mitsui Mining & Smelting Co., Ltd.
Stearic acid: “LUNAC S-20” manufactured by Kao Corporation
Resin: “T-REZ RA100” (aliphatic hydrocarbon resin) manufactured by ENEOS Materials Corporation
Processing aid: “Aflax 16” manufactured by Lanxess
Vulcanization accelerator: “Nocceler CZ-G” manufactured by Ouchi Shinko Chemical Industrial Co., Ltd.
Sulfur: “Oil-treated powdered sulfur” (sulfur content 80 mass %) manufactured by Tsurumi Chemical Industry Co., Ltd.

Rubber compositions were prepared using the Banbury mixer according to the formulations (parts by mass) shown in Tables 1 and 2 below. Specifically, first, in the first mixing stage, all additives except for the vulcanization accelerator and the sulfur were added to the diene rubber component along with the carbon black, the silica, and the hydrazide compound, and the mixture was kneaded (discharge temperature: 160 °C).

The vulcanization accelerator and the sulfur were added to the obtained kneaded material in the final mixing stage and kneading was performed (discharge temperature=100 °C) to produce the rubber composition. Note that in the sulfur column in the table, the numbers in parentheses indicate the parts by mass of pure sulfur content excluding the mass of oil.

Each of the resulting rubber compositions was vulcanized at 160 °C for 30 minutes. The vulcanized rubber samples thus obtained were evaluated for hardness, low heat generation properties, cut resistance, and bending fatigue resistance.

Evaluation methods are as follows.

### (1) Hardness (23 °C)

The hardness was measured at a temperature of 23 °C using a durometer type A in accordance with JIS K6253-3:2012. A larger value indicates a higher hardness at 23 °C. A target hardness is 55 or higher.

### (2) Low Heat Generation Properties

In accordance with JIS K6394:2007, a viscoelasticity tester manufactured by Toyo Seiki Seisaku-sho, Ltd. was used to measure a loss factor tan δ of a rubber sample (2.0 mm×5.0 mm×20.0 mm) at a frequency of 10 Hz, a static strain of 10%, a dynamic strain of 1%, and a temperature of 35 °C (tensile mode). The value of Comparative Example 1 was set to 100, and the values of Examples and Comparative Examples were each indicated as an index. A smaller value indicates a smaller loss factor tan δ, that is, indicates that the sample is less likely to generate heat, and has excellent low heat generation properties (low fuel consumption). A target value for the low heat generation properties is 89 or less.

### (3) Cut Resistance

In accordance with JIS K6252-1:2015, a test piece (thickness 2 mm) was prepared by punching out a crescent shape and making a 0.50±0.08 mm notch in the center of the depression. A tensile test was carried out using a tensile tester manufactured by Shimadzu Corporation at a speed of 500 mm/min to measure the tearing strength of the test piece. The value of Comparative Example 1 was set to 100, and the values of Examples and Comparative Examples were each indicated as an index. A larger value indicates better cut resistance. A target value for the cut resistance is 110 or more.

### (4) Bending Fatigue Resistance

In accordance with JIS K6260:2017, the test piece was subjected to the De Mattia flex crack growth test at 23 °C, and the number of times of the test until the crack grows to 2 mm was measured. A value of 80% of the measured value of Comparative Example 1 was set as a reference value, and the measured value of each of Examples and Comparative Examples was indicated as A if it was equal to or greater than the reference value, and as B if it was less than the reference value.

TABLE 1

| | Comp. | Comp. | Comp. | Comp. | Comp. | Comp. | Comp. | Comp. | Comp. |
|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 |
| Formulation (parts by mass) | | | | | | | | | |
| Natural rubber | 54.0 | 54.0 | 54.0 | 54.0 | 54.0 | 54.0 | 54.0 | 54.0 | 100.0 |
| Butadiene rubber | 46.0 | 46.0 | 46.0 | 46.0 | 46.0 | 46.0 | 46.0 | 46.0 | |
| Carbon Black-1 | | | | | | | | 30.0 | |
| Carbon Black-2 | 30.0 | 30.0 | 30.0 | 30.0 | 30.0 | 30.0 | 40.0 | | 30.0 |
| Carbon Black-3 | | | | | | | | | |
| Silica | 10.0 | 10.0 | 10.0 | 10.0 | 10.0 | 10.0 | | 10.0 | 10.0 |
| Hydrazide compound | | | 0.8 | | | 0.8 | 0.8 | 0.8 | 0.8 |
| Silane coupling agent | 0.8 | 0.8 | 0.8 | 0.8 | 0.8 | 0.8 | 0.8 | 0.8 | 0.8 |
| Oil | 1.0 | 1.0 | 1.0 | 1.0 | 1.0 | 1.0 | 1.0 | 1.0 | 1.0 |
| Wax | 1.5 | 1.5 | 1.5 | 1.5 | 1.5 | 1.5 | 1.5 | 1.5 | 1.5 |
| Antioxidant-1 | 3.8 | 3.8 | 3.8 | 3.8 | 3.8 | 3.8 | 3.8 | 3.8 | 3.8 |
| Antioxidant-2 | 1.9 | 1.9 | 1.9 | 1.9 | 1.9 | 1.9 | 1.9 | 1.9 | 1.9 |
| Zinc oxide | 3.0 | 3.0 | 3.0 | 3.0 | 3.0 | 3.0 | 3.0 | 3.0 | 3.0 |
| Stearic acid | 2.0 | 2.0 | 2.0 | 2.0 | 2.0 | 2.0 | 2.0 | 2.0 | 2.0 |
| Resin | 1.5 | 1.5 | 1.5 | 1.5 | 1.5 | 1.5 | 1.5 | 1.5 | 1.5 |
| Processing aid | 1.0 | 1.0 | 1.0 | 1.0 | 1.0 | 1.0 | 1.0 | 1.0 | 1.0 |
| Vulcanization accelerator | 0.7 | 1.5 | 0.7 | 1.0 | 2.0 | 2.0 | 1.5 | 1.5 | 1.5 |
| Sulfur | 2.5 (2.0) | 1.5 (1.2) | 2.5 (2.0) | 2.0 (1.6) | 1.0 (0.8) | 1.0 (0.8) | 1.5 (1.2) | 1.5 (1.2) | 1.5 (1.2) |
| Mass ratio of vulcanization | 0.35 | 1.25 | 0.35 | 0.63 | 2.50 | 2.50 | 1.25 | 1.25 | 1.25 |
| accelerator/sulfur | | | | | | | | | |
| Evaluation | | | | | | | | | |
| Hardness | 53 | 57 | 51 | 53 | 58 | 59 | 55 | 60 | 58 |
| Low heat generation | 100 | 91 | 82 | 93 | 73 | 73 | 88 | 119 | 111 |
| properties (index) | | | | | | | | | |
| Cut resistance (index) | 100 | 134 | 139 | 127 | 151 | 141 | 104 | 144 | 127 |
| Bending fatigue resistance | A | A | A | A | B | B | A | A | B |

TABLE 2

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| Formulation (parts by mass) | | | | | | | | | |
| Natural rubber | 54.0 | 54.0 | 54.0 | 54.0 | 54.0 | 54.0 | 54.0 | 40.0 | 54.0 |
| Butadiene rubber | 46.0 | 46.0 | 46.0 | 46.0 | 46.0 | 46.0 | 46.0 | 60.0 | 46.0 |
| Carbon black-1 | | | | | | | | | |
| Carbon black-2 | 30.0 | 30.0 | 30.0 | 35.0 | 25.0 | 40.0 | 10.0 | 30.0 | 30.0 |
| Carbon black-3 | | | | | | | 20.0 | | |
| Silica | 10.0 | 10.0 | 10.0 | 5.0 | 10.0 | 5.0 | 10.0 | 10.0 | 10.0 |
| Hydrazide compound | 0.8 | 0.8 | 2.0 | 0.8 | 0.8 | 0.8 | 0.8 | 0.8 | 0.8 |
| Silane coupling agent | 0.8 | 0.8 | 0.8 | 0.8 | 0.8 | 0.8 | 0.8 | 0.8 | 0.8 |
| Oil | 1.0 | 1.0 | 1.0 | 1.0 | 1.0 | 1.0 | 1.0 | 1.0 | 1.0 |
| Wax | 1.5 | 1.5 | 1.5 | 1.5 | 1.5 | 1.5 | 1.5 | 1.5 | 1.5 |
| Antioxidant-1 | 3.8 | 3.8 | 3.8 | 3.8 | 3.8 | 3.8 | 3.8 | 3.8 | 3.8 |
| Antioxidant-2 | 1.9 | 1.9 | 1.9 | 1.9 | 1.9 | 1.9 | 1.9 | 1.9 | 1.9 |
| Zinc oxide | 3.0 | 3.0 | 3.0 | 3.0 | 3.0 | 3.0 | 3.0 | 3.0 | 3.0 |
| Stearic acid | 2.0 | 2.0 | 2.0 | 2.0 | 2.0 | 2.0 | 2.0 | 2.0 | 2.0 |
| Resin | 1.5 | 1.5 | 1.5 | 1.5 | 1.5 | 1.5 | 1.5 | 1.5 | 1.5 |
| Processing aid | 1.0 | 1.0 | 1.0 | 1.0 | 1.0 | 1.0 | 1.0 | 1.0 | 1.0 |
| Vulcanization accelerator | 1.5 | 1.0 | 1.5 | 1.5 | 1.5 | 1.5 | 1.5 | 1.5 | 1.8 |
| Sulfur | 1.5 (1.2) | 2.0 (1.6) | 1.5 (1.2) | 1.5 (1.2) | 1.5 (1.2) | 1.5 (1.2) | 1.5 (1.2) | 1.5 (1.2) | 1.2 (0.96) |
| Mass ratio of vulcanization | 1.25 | 0.63 | 1.25 | 1.25 | 1.25 | 1.25 | 1.25 | 1.25 | 1.88 |
| accelerator/sulfur | | | | | | | | | |
| Evaluation | | | | | | | | | |
| Hardness | 57 | 55 | 59 | 56 | 55 | 58 | 55 | 58 | 57 |
| Low heat generation | 86 | 81 | 87 | 84 | 81 | 89 | 77 | 86 | 83 |
| properties (index) | | | | | | | | | |
| Cut resistance (index) | 120 | 126 | 115 | 117 | 115 | 122 | 112 | 110 | 134 |
| Bending fatigue resistance | A | A | A | A | A | A | A | A | A |

Results are as shown in Tables 1 and 2. Comparative Example 1 is an example in which no hydrazide compound was compounded, and the vulcanization accelerator and the sulfur were compounded such that the mass ratio of the vulcanization accelerator to the sulfur (hereinafter may simply be referred to as the mass ratio) was equal to or lower than the lower limit value. Comparative Example 1 was poor in hardness, low heat generation properties, and cut resistance. Comparative Example 2 is an example in which compounding was performed such that the mass ratio became a specified value as compared with that of Comparative Example 1. Comparative Example 2 was excellent in hardness, cut resistance, and bending fatigue resistance, but was poor in low heat generation properties. Comparative Example 3 is an example in which a hydrazide compound was compounded as compared with Comparative Example 1. In Comparative Example 3, the low heat generation properties was improved as compared with that of Comparative Example 1, but the hardness was poor.

Comparative Example 4 is an example in which compounding was performed such that the mass ratio became a specified value as compared with that of Comparative Example 1. In Comparative Example 4, the low heat generation properties and the cut resistance were improved as compared with those of Comparative Example 1, but the low heat generation properties was not satisfactory. The hardness still did not reach the target value (55 or more). Comparative Example 5 is an example in which compounding was performed such that the mass ratio exceeded the upper limit value as compared with that of Comparative Example 4. In Comparative Example 5, the hardness and the low heat generation properties were improved as compared with those of Comparative Example 4, and the cut resistance was also excellent, but the bending fatigue resistance was poor. Comparative Example 6 is an example in which the hydrazide compound was compounded in a specified amount as compared with that of Comparative Example 5. Comparative Example 6 exhibited excellent effects in terms of hardness, low heat generation properties, and cut resistance that were roughly equivalent to those of Comparative Example 5, but was still poor in the bending fatigue resistance.

Comparative Example 7 is an example in which no silica was compounded. In Comparative Example 7, the hardness, low heat generation properties, and cut resistance were better than those of Comparative Example 1, but the cut resistance was not satisfactory.

Comparative Example 8 is an example in which carbon black having a nitrogen adsorption specific surface area (N₂SA) exceeding the upper limit value was compounded. In Comparative Example 8, the hardness and cut resistance were improved as compared with those of Comparative Example 1, but the low heat generation properties was significantly deteriorated.

Comparative Example 9 is an example in which only a natural rubber was used as the diene rubber component. In Comparative Example 9, the hardness and cut resistance were improved as compared with those of Comparative Example 1, but the low heat generation properties was significantly deteriorated and the bending fatigue resistance was also poor.

In contrast, in Examples 1 to 9, the hardness, low heat generation properties, and cut resistance were all improved as compared to those of Comparative Example 1, and the bending fatigue resistance also exceeded the reference value.

Note that in various numerical ranges described in the specification, upper limit values and lower limit values thereof can be freely combined, and all combinations thereof are described in the present specification as preferable numerical ranges. The description of the numerical range of “X to Y” means X or more and Y or less.

Although certain embodiments of the invention have been described above, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the disclosure. These embodiments, their omissions, substitutions, changes, and the like are included in the invention described in the scope of claims and equivalents thereof, as well as being included in the scope and gist of the invention.

What is claimed is:

1. A rubber composition for a sidewall, comprising:
a diene rubber component containing a natural rubber and a butadiene rubber;
carbon black having a nitrogen adsorption specific surface area (N₂SA) of 20 m²/g to 60 m²/g;
silica;
a hydrazide compound represented by the following general formula (1): 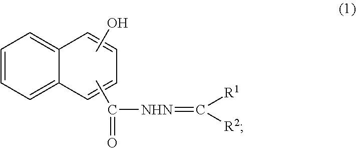
a vulcanization accelerator; and
sulfur, wherein
in the formula (1), R¹ and R² each independently represent an alkyl group having 1 to 18 carbon atoms,
relative to 100 parts by mass of the diene rubber component, a content of the carbon black is 20 parts by mass to 50 parts by mass, and a content of the hydrazide compound is 0.5 parts by mass to 5.0 parts by mass, and
a mass ratio of the vulcanization accelerator to the sulfur is 0.60 to 2.00.

2. The rubber composition for a sidewall according to claim 1, wherein
100 parts by mass of the diene rubber component contains 40 parts by mass to 60 parts by mass of the natural rubber and 40 parts by mass to 60 parts by mass of the butadiene rubber.

3. The rubber composition for a sidewall according to claim 1, wherein
relative to 100 parts by mass of the diene rubber component, a content of the silica is 5 parts by mass to 20 parts by mass.

4. The rubber composition for a sidewall according to claim 1, wherein
relative to 100 parts by mass of the diene rubber component, a total content of the carbon black and the silica is 30 parts by mass to 55 parts by mass.

5. The rubber composition for a sidewall according to claim 1, wherein
a content ratio of the carbon black to the silica (carbon black/silica) is 2 to 9 in terms of mass ratio.

6. The rubber composition for a sidewall according to claim 1, wherein
the vulcanization accelerator contains a sulfenamide-based vulcanization accelerator.

7. A pneumatic tire comprising:
a sidewall produced using the rubber composition for a sidewall according to claim 1.
